(19) United States
(12) Patent Application Publication
(10) Pub. No.: US 2025/0190530 A1
(43) Pub. Date: Jun. 12, 2025

(54) AUTHENTICATION DEVICE, AUTHENTICATION METHOD, AND PROGRAM

(71) Applicant: NEC Corporation, Minato-ku, Tokyo (JP)

(72) Inventor: Keisuke YABU, Tokyo (JP)

(73) Assignee: NEC Corporation, Minato-ku, Tokyo (JP)

(21) Appl. No.: 18/845,927

(22) PCT Filed: Mar. 16, 2022
(86) PCT No.: PCT/JP2022/011944

§ 371 Date: Sep. 11, 2024

(51) Int. Cl. G06F 21/32; G06F 21/62

(52) U.S. Cl. CPC G06F 21/32; G06F 21/6218

(57) ABSTRACT

An authentication device is connected to a database that corresponds to an identifier of a class of first biometric information subjected to classification. The database stores therein second biometric information of a person of the first biometric information. The authentication device specifies, among the first biometric information and the second biometric information of a person included in one image, the identifier of the class obtained by classification of the first biometric information, and performs authentication using second biometric information of a plurality of persons stored by the database that corresponds to the identifier of the class of the first biometric information and second biometric information included in the image

### TECHNICAL FIELD

This invention relates to an authentication device, an authentication method, and a program.

### BACKGROUND ART

Technology to authenticate a person appearing in an image is widely used. Patent Document 1 discloses a technique in which the iris patterns of the right and left eyes are registered in a database, and the iris patterns of the right and left eyes captured by a camera are matched with the iris patterns of the right and left eyes registered in the database.

### PRIOR ART DOCUMENT

### Patent Document

Patent Document 1: Japanese Unexamined Patent Application Publication No. 2017-142772

### SUMMARY

### Problems to be Solved by the Invention

In the authentication technology described above, there is a need for technology to improve the accuracy of authentication.

It is therefore an example object of this invention to provide an authentication device, an authentication method, and a program that solve the above-mentioned problem.

### Means for Solving the Problem

According to the first example aspect of the invention, the authentication device is connected to a storage means that corresponds to an identifier of a class of first biometric information subjected to classification and that stores therein second biometric information of a person of the first biometric information, comprising a class specifying means that specifies, among the first biological information and the second biological information of a person included in one image, the identifier of the class obtained by classification of the first biological information, and an authentication means that performs authentication using second biological information of a plurality of persons stored by the storage means that corresponds to the identifier of the class of the first biological information and second biological information included in the image.

According to the second example aspect of the invention, the authentication method is one in which an authentication device that is connected to a storage means that corresponds to an identifier of a class of first biometric information subjected to classification and that stores therein second biometric information of a person of the first biometric information specifies, among the first biometric information and the second biometric information of a person included in one image, the identifier of the class obtained by classification of the first biometric information; and performs authentication using second biological information of a plurality of persons stored by the storage means that corresponds to the identifier of the class of the first biological information and second biological information included in the image.

According to the third example aspect of the invention, the program causes a computer of an authentication device that is connected to a storage means that corresponds to an identifier of a class of first biometric information subjected to classification and that stores therein second biometric information of a person of the first biometric information to function as a class specifying means that specifies, among the first biological information and the second biological information of a person included in one image, the identifier of the class obtained by classification of the first biological information, and an authentication means that performs authentication using second biological information of a plurality of persons stored by the storage means that corresponds to the identifier of the class of the first biological information and second biological information included in the image.

### Effect of Invention

According to the present invention, it is possible to improve the accuracy of authentication using images.

### BRIEF DESCRIPTION OF THE DRAWINGS

FIG. 1 is a diagram showing a schematic diagram of the authentication system including the authentication device according to the example embodiment.

FIG. 2 is a hardware configuration diagram of the authentication device according to the example embodiment.

FIG. 3 is a functional block diagram of the authentication device according to the example embodiment.

FIG. 4 is a diagram showing the process flow of the authentication device in the registration process according to the example embodiment.

FIG. 5 is a diagram showing the processing flow of the authentication device in the authentication process according to the example embodiment.

FIG. 6 is a first diagram showing the schematic configuration of an authentication system including the authentication device according to another example embodiment.

FIG. 7 is a second diagram showing the schematic configuration of an authentication system including an authentication device according to another example embodiment.

FIG. 8 is a third diagram showing the schematic configuration of an authentication system including an authentication device according to another example embodiment.

FIG. 9 is a diagram showing the minimum configuration of the authentication device according to the example embodiment.

FIG. 10 is a diagram showing the processing flow of the authentication device with the minimum configuration according to the present example embodiment.

### EXAMPLE EMBODIMENTS

The following is a description of an authentication device according to one example embodiment of the present invention with reference to the drawings.

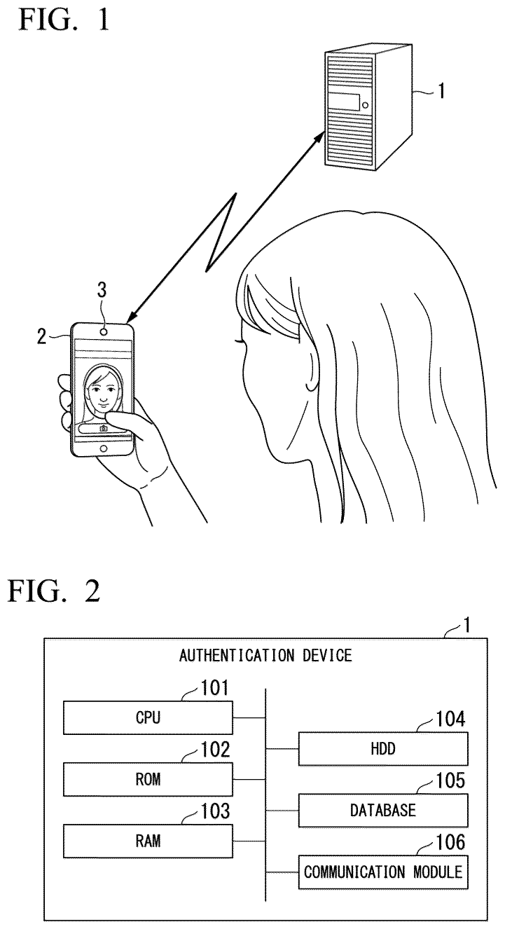

FIG. 1 is a diagram showing a schematic diagram of the authentication system including an authentication device according to the present example embodiment.

An authentication device 1 communicatively connects to a mobile terminal 2, such as a smartphone, as an example. The user captures an image of his or her face using a camera 3 on the mobile terminal 2. The authentication device 1 authenticates the user by acquiring the image generated by such image capture from the mobile terminal 2. The image shows the user's face. The authentication device 1 performs authentication using iris information of the eyes in the image and feature information of the face. In the present example embodiment, iris information is the first biometric information of a person and facial feature information is the second biometric information of a person. The authentication device 1 uses these two biometric data appearing in a single image for authentication. Biometric information is an example of feature information.

FIG. 2 is a hardware configuration diagram of the authentication device according to the present example embodiment.

As this figure shows, the authentication device 1 is a computer equipped with each piece of hardware such as a CPU (Central Processing Unit) 101, ROM (Read Only Memory) 102, RAM (Random Access Memory) 103, HDD (Hard Disk Drive) 104, database 105, communication module 106, and the like. The mobile terminal 2 may have a similar hardware configuration. The authentication device 1 is equipped with a plurality of databases 105. Each database 105 may be configured as a device different from the authentication device 1.

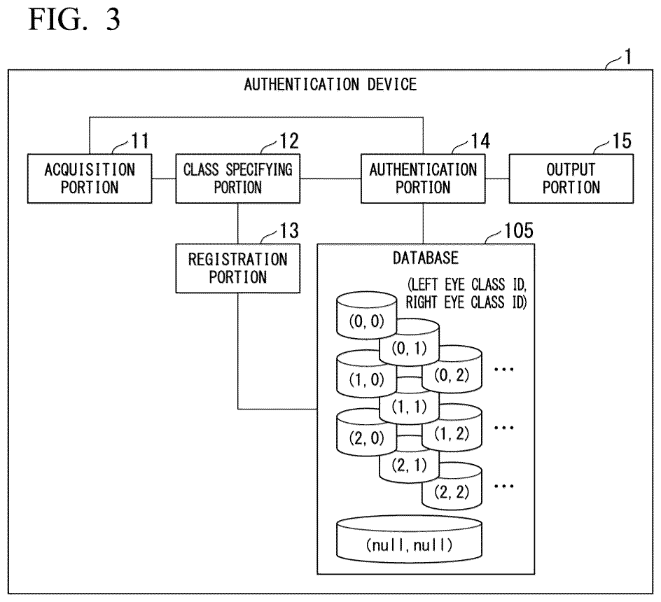

FIG. 3 is a functional block diagram of the authentication device according to the example embodiment.

The authentication device 1 performs the functions of an acquisition portion 11, a class specifying portion 12, a registration portion 13, an authentication portion 14, and an output portion 15 in a case where the CPU 101 starts the authentication program.

The acquisition portion 11 acquires images from the mobile terminal 2.

The class specifying portion 12 specifies the identifier of a class obtained by classification of the iris information, among the iris information (first biometric information) of the eyes of the person included in the image and the facial feature information (second biometric information).

The registration portion 13 registers the facial feature information of the person in question in the database corresponding to the identifier of the class of the iris information.

The authentication portion 14 authenticates the person using the facial feature information of multiple persons stored in the database corresponding to the identifier of the class of the iris information and the facial feature information of the person in the image.

The output portion 15 outputs the authentication result.

In the present example embodiment, the registration portion 13 classifies the iris information of the left eye and the right eye included in the image acquired in the registration process, and registers the facial feature information of the person appearing in the image in the database 105 corresponding to the class ID of the iris information of the left eye and the class ID of the iris information of the right eye. The authentication portion 14 classifies each of the iris information of the left eye and the right eye included in the image newly acquired at the time of authentication, and performs authentication using the facial feature information of multiple persons stored in the database 105 corresponding to each identifier of the class ID of the iris information of the left eye and the class ID of the iris information of the right eye, and the facial feature information of the person included in the image newly acquired at the time of authentication.

The authentication device 1 of the present example embodiment has multiple databases 105 that can be uniquely identified by two identifiers: the class ID of the right eye and the class ID of the left eye. For example, if there are 10 class IDs for the right eye and 10 class IDs for the left eye, the authentication device 1 has 10*10=100 (“*” denotes multiplication) databases 105. If the class ID of the right eye E1 and the class ID of the left eye E2 are represented by (E1, E2), each database 105 can be identified as one of 100 databases: (0, 0), (0, 1), (0, 2) . . . (0, 9), (1, 0), (1, 1), (1, 2) . . . (1, 9), . . . (9, 0), (9, 1), (9, 2) . . . (9, 9).

In a case where information on an eye region of the face in an image is taken as input in advance, the authentication device 1 stores information about a classification model that outputs the class ID in a case where the feature of that eye is classified. In a case where an image is acquired, the class specifying portion 12 of the authentication device 1 inputs information on an eye region contained in the image to a neural network or the like generated using the classification model, and outputs the class ID as a result.

The classification model is information obtained by machine learning the relationship between a large number of eye images and the correct data of the eye class IDs in those images, including, as an example, information such as neural network weights. The class specifying portion 12 uses this classification model to identify the class ID of the left eye and the class ID of the right eye, respectively. Classification of eye features, as an example, is done by size, such as the radius of the pupil of the eye, or by color or other features. The authentication device 1 may generate classification models by methods other than machine learning methods in a case where using neural networks.

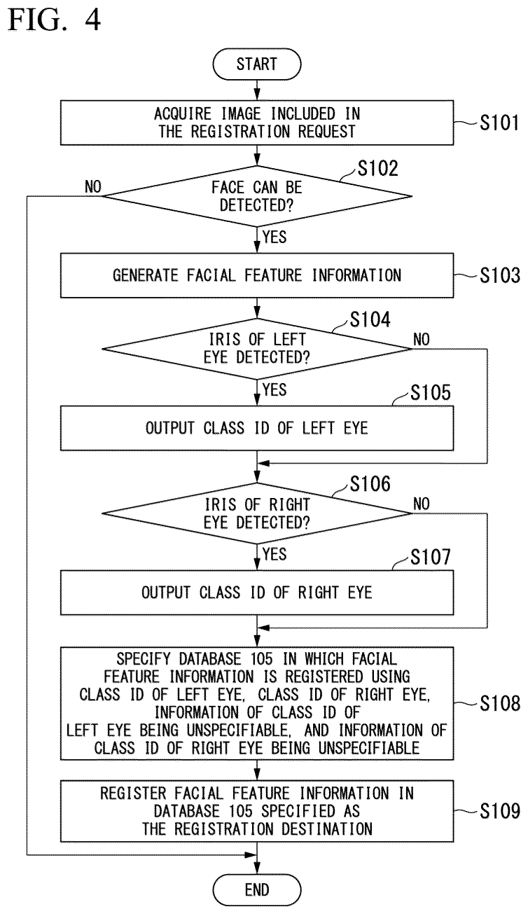

FIG. 4 shows the processing flow of the authentication device in the registration process.

In the registration process, the user takes a picture of his or her face using the mobile terminal 2. The mobile terminal 2 generates an image from the image capture. The user's face appears in the image. The more pixels in the image, the better. The user instructs the mobile terminal 2 to start the registration process. The mobile terminal 2 sends a registration request including the image to the authentication device 1.

The authentication device 1 receives the registration request. The acquisition portion 11 of the authentication device 1 acquires the image included in the registration request (Step S101). The acquisition portion 11 determines whether or not a face can be detected from the image (Step S102). The acquisition portion 11 terminates the registration process if no face can be detected. If a face can be detected, the acquisition portion 11 generates facial feature information based on the facial region included in the image (Step S103).

The acquisition portion 11 outputs the image to the class specifying portion 12. The class specifying portion 12 determines whether the iris of the left eye of the face in the image can be detected (Step S104). The class specifying portion 12 specifies the class ID of the left eye if the iris of the left eye can be detected. Specifically, the class specifying portion 12 inputs information on the area of the left eye into a neural network using a classification model, and outputs the resulting class ID of the left eye (Step S105).

The class specifying portion 12 also determines whether the iris of the right eye of the face in the image can be detected (Step S106). The class specifying portion 12 specifies the class ID of the right eye if the iris of the right eye can be detected. Specifically, the class specifying portion 12 inputs information on the area of the right eye into a neural network using a classification model, and outputs the resulting class ID of the right eye (Step S107). If the iris of the left or right eye cannot be detected, the class specifying portion 12 may output information that the class ID of the left or right eye cannot be identified.

The class specifying portion 12 outputs the class ID of the left eye, the class ID of the right eye, the output result showing information about the class ID of the left or right eye being unspecifiable, and the image to the registration portion 13. From the output results, the registration portion 13 uses the class ID of the left eye, the class ID of the right eye, information of the class ID of the left eye being unspecifiable, and information of the class ID of the right eye being unspecifiable to specify the database 105 in which the facial feature information is to be registered (Step S108). If both class IDs of the left eye and the right eye have been identified, the registration portion 13 specifies only the database 105 corresponding to the class ID of the left eye and the class

ID of the right eye as the database 105 in which the facial feature information is to be registered. If, for example, the class ID for the left eye is “1” and the class ID for the right eye is “3”, the registration portion 13 specifies the database 105 corresponding to the information in (1, 3) as the database in which the facial feature information is to be registered. The process of the registration portion 13 is one example aspect of the process of classifying the iris information for each of the left eye and the right eye, which is the first biometric information, into a class and registering the second biometric information (facial feature information) of the person of the first biometric information in the storage means that corresponds to the identifier of the class of the iris information of the left eye and the identifier of the class of the iris information of the right eye.

If only the class ID of the left eye can be specified, the registration portion 13 specifies multiple databases 105 corresponding to the class ID of the left eye as the databases 105 in which the facial feature information is to be registered. Specifically, if the class ID of the left eye is “5” and the class ID of the right eye has not been specified, the registration portion 13 specifies the 10 databases 105 of (5, 0), (5, 1) . . . (5, 9) as databases in which facial feature information is to be registered. The process of the registration portion 13 is one example aspect of the process of registering the second biometric information (facial feature information) of the person of the first biometric information in all storage means specified by all the identifiers of the class relating to the left eye, in a case where only the identifier of the class obtained by classification of the iris information of the left eye can be specified, the iris information of the left eye being the first biometric information.

If only the class ID of the right eye can be specified, the registration portion 13 specifies multiple databases 105 corresponding to the class ID of the right eye as the databases 105 in which the facial feature information is to be registered. Specifically, if the class ID of the right eye is “4” and the class ID of the left eye has not been specified, the registration portion 13 specifies the 10 databases 105 of (4, 0), (4, 1) . . . (4, 9) as databases in which facial feature information is to be registered. The process of the registration portion 13 is one example aspect of the process of registering the second biometric information (facial feature information) of the person of the first biometric information in all storage means specified by all the identifiers of the class relating to the right eye, in a case where only the identifier of the class obtained by classification of the iris information of the→eye can be specified, the iris information of the right eye being the first biometric information.

If neither the class ID of the left eye nor the class ID of the right eye can be specified, the registration portion 13 specifies all the databases 105 as the databases 105 in which the facial feature information is to be registered. Specifically, if neither the class ID of the left eye nor the class ID of the right eye can be specified, the registration portion 13 specifies the 100 databases 105 of (0, 0), (0, 1), (0, 2) . . . (0, 9), (1, 0), (1, 1), (1, 2) . . . (1, 9), . . . (9, 0), (9, 1), (9, 2) . . . (9, 9) as the databases 105 to which the facial feature information is to be registered. The registration portion 13 registers the facial feature information in the databases 105 specified as the registration destination (Step S109). The authentication device 1 is further equipped with one database 105 that indicates (null, null), indicating neither the class ID of the left eye nor the class ID of the right eye, and registers the facial feature information of all users who have requested registration in that database.

This means that the user's facial feature information will only be registered in any one or a number of databases 105 of the class IDs of the left or right eye out of all the databases 105 to which the authentication device 1 will register the facial feature information if the class ID of the eye classification can be specified from the image.

Here, for example, twins are highly correlated in facial feature information. Therefore, if the facial feature information of each of the twins was registered in one database 105 and the authentication process proceeded using the registered facial feature information, a recognition error could occur in the authentication of one of the twins due to the calculation result of high similarity with the facial feature information of the other of the twins. Eye feature information is often different, even for twins, and this increases the likelihood that twins' facial feature information will be registered in separate databases. Then, based on the class ID of the eyes of one of the twins specified by the authentication device 1 at the time of authentication, the authentication process is performed using only the facial feature information registered in that database 105. By doing so, the authentication process can be performed with higher accuracy than using a single database in which the twins' facial feature information is registered. In other words, in a case where authenticating one of a pair of twins, the authentication process is performed using only the database 105 in which the facial feature information of that person is presumed to be registered, eliminating the need to make similarity judgments with the facial feature information of the other twin, thereby improving authentication accuracy.

Here, the above process explains that the class specifying portion 12 inputs information on the eye region of the person's face in an image to a neural network generated using a classification model and outputs a class ID. However, the neural network generated using the classification model may output a numerical value representing the degree of association with the features of each of the 10 classes of class IDs 0 through 9. In this case, the class specifying portion 12 may input the information on the eye region of the person's face in the image into a neural network generated using a classification model, output the degree of association with each of the 10 classes, and identify the class ID with the highest degree of association as a result.

In the process described above, the mobile terminal 2 also sends a registration request including an image to the authentication device 1. However, the mobile terminal 2 may specify facial feature information and eye region image information from the image and send a registration request containing only the facial feature information and eye region image information to the authentication device 1. This may allow the authentication device 1 to omit the process of generating facial feature information and specifying the eye regions. The authentication device 1 may use the eye region image information included in the registration request to specify the class ID and register the facial feature information included in the registration request in the database 105 specified based on the class ID.

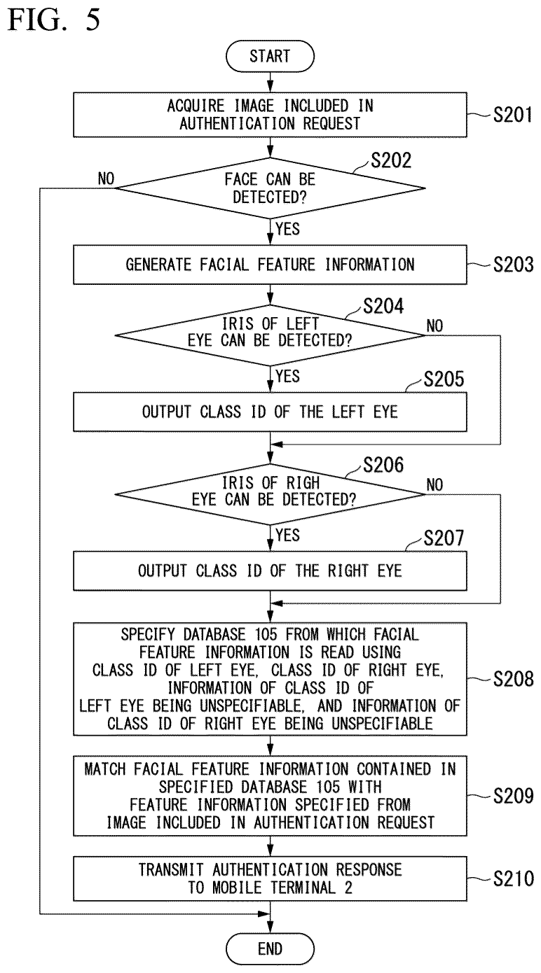

FIG. 5 is a diagram showing the processing flow of the authentication device in the registration process.

In the authentication process, the user takes a picture of his or her face using the mobile terminal 2. The mobile terminal 2 generates an image from the image capture. The user's face appears in the image. The more pixels in the image, the better. The user instructs the mobile terminal 2 to start the authentication process. The mobile terminal 2 sends an authentication request including the image to the authentication device 1.

The authentication device 1 receives the authentication request. The acquisition portion 11 of the authentication device 1 acquires the image included in the authentication request (Step S201). The acquisition portion 11 determines whether or not a face can be detected from the image (Step S202). The acquisition portion 11 terminates the authentication process if no face can be detected. If a face can be detected, the acquisition portion 11 generates facial feature information based on the facial region included in the image (Step S203).

The acquisition portion 11 outputs the image to the class specifying portion 12. The class specifying portion 12 determines whether the iris of the left eye of the face in the image can be detected (Step S204). The class specifying portion 12 identifies the class ID of the left eye if the iris of the left eye can be detected. Specifically, the class specifying portion 12 inputs information on the region of the left eye into a neural network using a classification model, and outputs the resulting class ID of the left eye (Step S205).

The class specifying portion 12 also determines whether the iris of the right eye of the face in the image can be detected (Step S206). The class specifying portion 12 identifies the class ID of the right eye if the iris of the right eye can be detected. Specifically, the class specifying portion 12 inputs information on the region of the right eye into a neural network using a classification model, and outputs the resulting class ID of the right eye (Step S207). If the iris of the left or right eye cannot be detected, the class specifying portion 12 may output information that the class ID of the left or right eye cannot be identified.

The class specifying portion 12 outputs the class ID of the left eye, the class ID of the right eye, the output result showing information about the class ID of the left or right eye not being identifiable, and the image to the authentication portion 14. From the output results, the authentication portion 14 uses the class ID of the left eye, the class ID of the right eye, information of the class ID of the left eye being unspecifiable, and information of the class ID of the right eye being unspecifiable to specify the database 105 from which the facial feature information is read (Step S208). If both class IDs of the left eye and the right eye have been specified, the authentication portion 14 specifies only the database 105 corresponding to the class ID of the left eye and the class ID of the right eye as the database 105 from which the facial feature information is read. If, for example, the class ID for the left eye is “5” and the class ID for the right eye is “7”, the registration portion 13 specifies the database 105 corresponding to the information in (5, 7) as the database from which the facial feature information is read.

If only the class ID of the left eye can be specified, the authentication portion 14 specifies multiple databases 105 corresponding to the class ID of the left eye as the databases 105 from which the facial feature information is to be read. Specifically, if the class ID of the left eye is “3” and the class ID of the right eye has not been specified, the authentication portion 14 specifies the 10 databases 105 of (3, 0), (3, 1) . . . (3, 9) as databases from which facial feature information is read. If neither the class ID of the left eye nor the class ID of the right eye can be specified, the authentication portion 14 identifies the database 105 corresponding to the (null, null) information as the database 105 from which the facial feature information is read. If neither the class ID of the left eye nor the class ID of the right eye can be specified, the authentication portion 14 may specify all of the 100 databases 105 of (0, 0), (0, 1), (0, 2) . . . (0, 9), (1, 0), (1, 1), (1, 2) . . . (1, 9), . . . (9, 0), (9, 1), (9, 2) . . . (9, 9) as the databases 105 from which the facial feature information is read. In that case, the database 105 corresponding to the (null, null) information need not be used.

After specifying the database 105 to be read, the authentication portion 14 matches the facial feature information contained in the specified database 105 with the feature information specified from the image included in the authentication request (Step S209). As a result of that matching, the authentication portion 14 specifies the user ID of the person whose facial feature information is included in the database 105 determined to be the most similar, with a similarity level equal to or greater than a predetermined threshold value. The authentication portion 14 outputs the specified user ID to the output portion 15. Note that it is assumed that the facial feature information and the person's user ID are recorded together in the database 105. If the similarity between the facial feature information contained in the specified database 105 and the facial feature information of the image included in the authentication request is less than the threshold value in either case, the authentication portion 14 outputs information indicating authentication failure to the output portion 15. If the above matching yields a similarity level equal to or greater than the threshold value, the authentication portion 14 may output information indicating successful authentication to the output portion 15. The output portion 15 transmits an authentication response indicating a user ID or authentication failure/authentication success as the output result to mobile terminal 2 (Step S210).

If the authentication response includes the user ID, the mobile terminal 2 judges the authentication to be successful in a case where the user ID concerned matches the user ID stored in its own device. This determination of whether or not the user IDs match and the determination of successful authentication in the case of a match may be performed by the authentication portion 14 of the authentication device 1. The mobile terminal 2 may also determine that authentication is successful if the authentication response contains information indicating successful authentication. The mobile terminal 2 may determine that authentication is unsuccessful if the authentication response contains information indicating unsuccessful authentication. If the mobile terminal 2 determines that the authentication is successful, it performs processing corresponding to the successful authentication. For example, if the mobile terminal 2 determines that authentication is successful, it may cancel the display of the login screen and change the mode to one in which the mobile terminal 2 can be used.

According to the above process, the authentication portion 14 of the authentication device 1 specifies the database 105 from which to read the facial feature information for authentication based on the specification of the class ID of the left eye and the class ID of the right eye. In this process, the authentication portion 14 inputs information on the eye regions of the person's face in the image to a neural network generated using a classification model, and outputs the degree of association with each of the 10 classes. The authentication portion 14 may then specify the database 105 from which to read the facial feature information for authentication based on one or more class IDs with a high degree of association. For example, suppose the threshold value of the degree of association is 0.85, and the authentication portion 14 calculates that the degree of association of the left eye feature information to class ID=“3” is 0.88, the degree of association of the left eye feature information to class ID=“6” is 0.89, and the degree of association of the right eye feature information to the class ID=“3” is 0.95. In this case, the authentication portion 14 may identify the two databases 105, (3, 3) and (6, 3), as the databases 105 from which facial feature information is read for authentication.

According to the above process, the authentication device 1 specifies the database 105 that is most likely to contain the facial feature information of the person in question, as estimated based on the classification of the person to be authenticated, and reads the facial feature information contained in that database 105 to perform the authentication process. Thus, it is possible to provide authentication technology that increases the likelihood of obtaining more accurate authentication results in a shorter period of time.

In the above process, the authentication device 1 performs authentication using an image that contains at least two pieces of biometric information: iris information (first biometric information) and facial feature information (second biometric information), but the same registration and authentication processes as described above may be performed using images that contain at least the two pieces of biometric data of biometric information other than iris information (first biometric data) and facial feature information (second biometric data). For example, suppose that a single image contains information on the shape of veins in the left and right palms and a face. In this case, during the registration process, the authentication device 1 specifies the class IDs that respectively classify the information on the shape of veins in each of the left and right palms, and registers the facial feature information of the person included in the respective image of the person in a database j105 according to those two class IDs. Then, at the time of authentication, the authentication portion 14 may acquire images containing information on the shape of veins in the left and right palms and the face, specify the class IDs of the left and right palms based on the information on the shape of the veins in the left and right palms, specify the database from which facial feature information is read, and perform authentication in the same manner.

### Other Example Embodiment 1

In the process described above, the authentication portion 14 of the authentication device 1 specifies the user ID of the person whose facial feature information is included in the database 105 determined to be the most similar, with a similarity level equal to or greater than a predetermined threshold value after the process of step S209. The authentication portion 14 of the authentication device 1 may change the threshold value used for this process depending on the state in which the iris could be detected. For example, the authentication portion 14 detects whether the irises of both eyes were detected in the first case, the iris of only the left eye was detected in the second case, the iris of only the right eye was detected in the third case, or the irises of both eyes were not detected in the fourth case. The authentication portion 14 changes the threshold value according to either the first, second, third, or fourth case. Specifically, the threshold value is changed to be higher in the order of first case<second or third case<fourth case. That is, the first threshold value in the first case is the lowest, the third threshold value in the fourth case is the highest, and the second threshold value in the second or third case is set between the first and third threshold values. In this way, the authentication portion 14 sets the highest threshold value in a case where the irises of both eyes cannot be obtained, so that authentication can be performed with high accuracy among many persons using only facial feature information. The threshold value is set higher in a case where the iris of one eye is obtained than in a case where the irises of both eyes are obtained, so that the facial feature information can be used to authenticate more persons with higher accuracy than in a case where the irises of both eyes are obtained.

### Other Example Embodiment 2

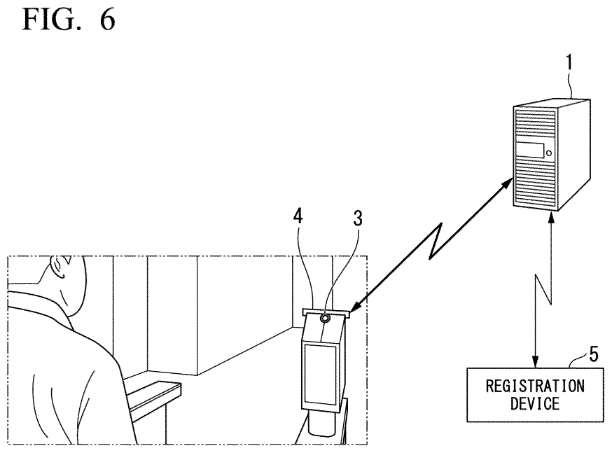

FIG. 6 is a first diagram showing the schematic configuration of an authentication system including the authentication device according to another example embodiment. As shown in FIG. 6, the authentication device 1 may be communicatively connected to a gate device 4 equipped with a camera 3. In this case, the authentication device 1 obtains the authentication request from the gate device 4 and performs the authentication process in the same manner as in the example embodiment described above. The registration process in this case should be performed in the same manner as in the example embodiment described above, upon receipt of a registration request from the authentication device 1 and the user's mobile terminal 2, or from the registration device 5. The gate device 4 is installed at boarding gates at airports, station ticket gates, entrances and exits of office buildings, and the like.

### Other Example Embodiment 3

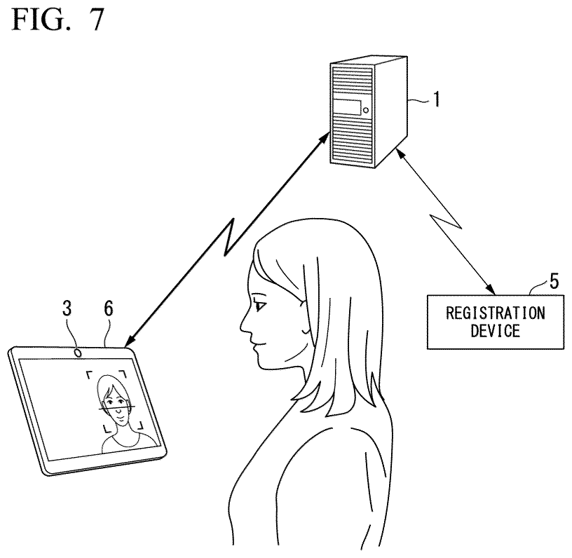

FIG. 7 is a second diagram showing the schematic configuration of an authentication system including an authentication device according to another example embodiment. As shown in FIG. 7, the authentication device 1 may be communicatively connected to a payment terminal 6 equipped with a camera 3. In this case, the authentication device 1 obtains the authentication request from the payment terminal 6 and performs the authentication process in the same manner as in the example embodiment described above. In this case, the registration process can also be performed in the same way as in the example embodiment described above, by receiving registration requests from the authentication device 1 and the user's mobile terminal 2, or from the registration device 5. The payment terminal 6 is installed in a store or other location.

### Other Example Embodiment 4

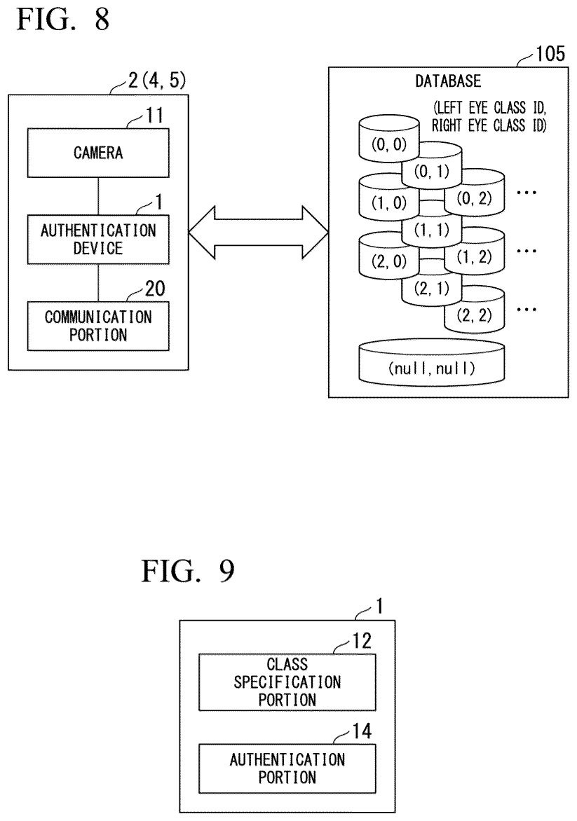

FIG. 8 is a third diagram showing the schematic configuration of an authentication system including an authentication device according to another example embodiment. In each of the above example embodiments, examples are described in which the authentication device is communicatively connected to the mobile terminal 2, the gate device 4, and the payment terminal 6 equipped with the camera 3, whereby the registration and authentication processes described above are performed. However, the functions of the authentication device 1 may also be functions provided inside the mobile terminal 2, gate device 4, and payment terminal 6. In this case, as an example, the authentication device 1 provided inside the mobile terminal 2, gate device 4, and payment terminal 6 may not have the function of the database 105, but may have a communication connection with an external database 105 to constitute an authentication system. In this case, the processing in the authentication device 1 is the same as in the other example embodiments described above, except that it communicates with the external database 105 to register and read out various information.

### Minimum Configuration Example Embodiment

FIG. 9 is a diagram showing the minimum configuration of the authentication device according to the example embodiment.

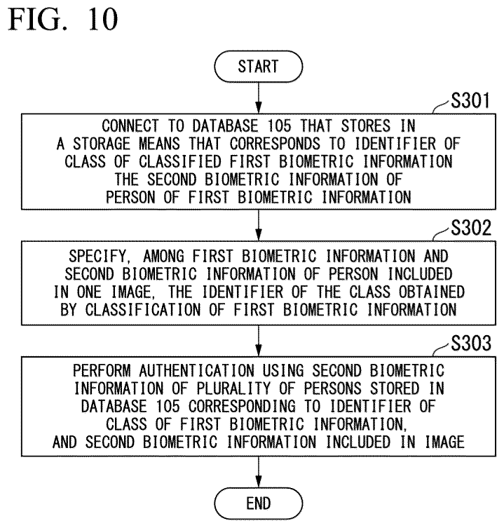

FIG. 10 is a diagram showing the processing flow of the authentication device with the minimum configuration according to the present example embodiment.

The authentication device 1 performs at least the functions of the class specifying portion 12 and the authentication portion 14.

The authentication device 1 connects to a database 105 that stores in a storage means that corresponds to an identifier of a class of the classified first biometric information the second biometric information of the person of the first biometric information (Step S301).

The class specifying portion 12 specifies, among the first biometric information and the second biometric information of the person included in one image, the identifier of the class obtained by classification of the first biometric information (Step S302).

The authentication portion 14 performs authentication using second biometric information of a plurality of persons stored in the database 105 corresponding to the identifier of the class of the first biometric information, and second biometric information that is included in the image (Step S303).

In the aforementioned example embodiments, examples are used to illustrate cases where a person's biometric information appears in an image. However, the authentication device 1 according to each of the above example embodiments may be used for authentication or matching in a case where the image contains biometric or characteristic information of an animal. The authentication device 1 according to each of the above-mentioned example embodiments may also be used for authentication or matching in a case where the image contains characteristic information of an object.

In this case, the authentication device 1 is connected to a storage means that corresponds to an identifier of a class of a first feature information subjected to classification and that stores therein second feature information of a target (animal or object) of the first feature information, and specifies, among the first feature information and the second feature information of the target in one image, the identifier of the class obtained by classification of the first feature information. The authentication device 1 then performs authentication and matching using second feature information of a plurality of targets stored by the storage means that corresponds to the identifier of the class of the first feature information, and second feature information that is included in the image.

In this case, the authentication device 1 classifies the first feature information into a class and registers the second feature information of the target of the first feature information in the storage means that corresponds to the identifier of the class of the first feature information concerned. The authentication device 1 classifies the first feature information of two different predetermined regions, which is the first feature information, into classes and registers the second feature information of the target of the first feature information in the database 105 corresponding to the identifiers of the classes of the two predetermined regions.

In the case of only being able to specify the class ID obtained by classification of one of the two predetermined regions in the target, which is the first feature information, the authentication device 1 registers the second characteristic information of the target having the first feature information in all the databases 105 specified by all the identifiers of the class relating to the one predetermined region.

In the case of only being able to specify the class ID obtained by classification of the other of the two predetermined regions in the target, which is the first feature information, the authentication device 1 registers the second characteristic information of the target having the first feature information in all the databases 105 specified by all the identifiers of the class relating to the other predetermined region.

Furthermore, in the aforementioned example, the explanation is given using the case where the image contains iris information, which is the first feature information, and facial feature information, which is the second feature information. However, the authentication device may also display fingerprints, voice information, acoustic information inside the ear, etc., as secondary feature information within the image.

Acoustic information inside the ear refers to reflected sound information of sound emitted inside the ear. These fingerprints, voice sound information, and acoustic information inside the ear may be obtained using sensors that sense these specific types of information. Even if the image does not include fingerprints, voice information, or acoustic information inside the ear, the authentication device 1 may acquire such information separately from the image and perform the registration or authentication process using the process described above. In other words, the authentication device 1 may store in a storage means that corresponds to the identifier of a class of first biometric information subjected to classification second biometric information of a person corresponding to the first biometric information, specify, among the first biometric information and the second biometric information of the person acquired respectively, an identifier of the class obtained by classification of the first biometric information, and perform authentication using second biometric information of the plurality of persons stored in the storage means that corresponds to the identifier of the class of the first biometric information, and the acquired second biometric information.

In each of the example embodiments described above, an example of a case in which the first feature information is iris information is described, but the first feature information may be fingerprints, voice information, or acoustic information inside the ear, and the second feature information may be facial feature information or biometric information (fingerprints, voice information, acoustic information inside the ear) that is different from the first feature information. These first and second feature information need not be obtained using images. In other words, the authentication device 1 may acquire the first feature information and the second feature information as information not included in an image as separate data at the start of the registration or authentication process, and perform the registration or authentication process in the same manner.

The authentication device 1 described above has a computer system inside. Each of the above-mentioned processes is stored in a computer-readable recording medium in the form of a program, and the computer reads and executes this program to perform the above-mentioned processes. Here, computer-readable recording media refers to magnetic disks, optical disks, CD-ROMs, DVD-ROMs, semiconductor memory, and the like. The computer program may also be delivered to a computer via a communication line, and the computer receiving this delivery may execute the program.

The above program may also be used to realize some of the aforementioned functions. Furthermore, it can be a so-called differential file (differential program), which can realize the aforementioned functions in combination with a program already recorded in the computer system.

Some or all of the above example embodiments may also be described as, but not limited to, the following supplementary notes.

### Supplementary Note 1

An authentication device connected to a storage means that corresponds to an identifier of a class of first biometric information subjected to classification and that stores therein second biometric information of a person of the first biometric information, comprising:
a class specifying means that specifies, among the first biometric information and the second biometric information of a person included in one image, the identifier of the class obtained by classification of the first biometric information; and
an authentication means that performs authentication using second biometric information of a plurality of persons stored by the storage means that corresponds to the identifier of the class of the first biometric information and second biometric information included in the image.

### Supplementary Note 2

An authentication device connected to a storage means that corresponds to an identifier of a class of first biometric information subjected to classification and that stores therein second biometric information of a person of the first biometric information, comprising:
a class specifying means that specifies, among the first biometric information and the second biometric information of a person that have been acquired, the identifier of the class obtained by classification of the first biometric information; and
an authentication means that performs authentication using second biometric information of a plurality of persons stored by the storage means that corresponds to the identifier of the class of the first biometric information and the acquired second biometric information.

### Supplementary Note 3

The authentication device as described in Supplementary Note 1 or Supplementary Note 2, wherein the first biometric information is iris information of the eyes.

### Supplementary Note 4

The authentication device as described in any one of Supplementary Note 1 to Supplementary Note 3,
wherein the first biometric information is the iris information of the left eye and the right eye, respectively.

### Supplementary Note 5

The authentication device as described in any one of Supplementary Note 1 to Supplementary Note 4, provided with
a registration means that classifies the first biometric information into a class and registers the second biometric information of the person of the first biometric information in the storage means that corresponds to the identifier of the class of the first biometric information.

### Supplementary Note 6

The authentication device as described in Supplementary Note 5,
wherein the registration means classifies the iris information for each of the left eye and the right eye, which is the first biometric information, into a class and registers the second biometric information of the person of the first biometric information in the storage means that corresponds to the identifier of the class of the iris information of the left eye and the identifier of the class of the iris information of the right eye.

### Supplementary Note 7

The authentication device as described in Supplementary Note 6,
wherein the registration means registers the second biometric information of the person of the first biometric information in all storage means specified by all the identifiers of the class relating to the left eye, in a case where only the identifier of the class obtained by classification of the iris information of the left eye can be specified, the iris information of the left eye being the first biometric information.

### Supplementary Note 8

The authentication device as described in Supplementary Note 6 or Supplementary Note 7,
wherein the registration means registers the second biometric information of the person of the first biometric information in all storage means specified by all the identifiers of the class relating to the right eye, in a case where only the identifier of the class obtained by classification of the iris information of the right eye can be specified, the iris information of the right eye being the first biometric information.

### Supplementary Note 9

The authentication device as described in any one of Supplementary Note 1 to Supplementary Note 8,
wherein the second biometric information is feature information of a face in the image.

### Supplementary Note 10

An authentication device connected to a storage means that corresponds to an identifier of a class of first feature information subjected to classification and that stores therein second feature information of a target of the first feature information, comprising:
a class specifying means that specifies, among the first feature information and the second feature information of a target included in one image, the identifier of the class obtained by classification of the first feature information; and
an authentication means that performs authentication using second feature information of a plurality of targets stored by the storage means that corresponds to the identifier of the class of the first feature information and second feature information included in the image.

### Supplementary Note 11

An authentication device connected to a storage means that corresponds to an identifier of a class of first feature information subjected to classification and that stores therein second feature information of a target of the first feature information, comprising:
a class specifying means that specifies, among the first feature information and the second feature information of a target that have been acquired, the identifier of the class obtained by classification of the first feature information; and
an authentication means that performs authentication using second feature information of a plurality of targets stored by the storage means that corresponds to the identifier of the class of the first feature information and the acquired second feature information.

### Supplementary Note 12

An authentication method comprising the steps of:
an authentication device that is connected to a storage means that corresponds to an identifier of a class of first biometric information subjected to classification and that stores therein second biometric information of a person of the first biometric information,
specifies, among the first biometric information and the second biometric information of a person included in one image, the identifier of the class obtained by classification of the first biometric information; and
performs authentication using second biometric information of a plurality of persons stored by the storage means that corresponds to the identifier of the class of the first biometric information and second biometric information included in the image.

### Supplementary Note 13

An authentication method comprising the steps of:
an authentication device that is connected to a storage means that corresponds to an identifier of a class of first biometric information subjected to classification and that stores therein second biometric information of a person of the first biometric information
specifying, among the first biometric information and the second biometric information of a person that have been acquired, the identifier of the class obtained by classification of the first biometric information; and
performing authentication using second biometric information of a plurality of persons stored by the storage means that corresponds to the identifier of the class of the first biometric information and the acquired second biometric information.

### Supplementary Note 14

An authentication method comprising the steps of:
an authentication device that is connected to a storage means that corresponds to an identifier of a class of first feature information subjected to classification and that stores therein second feature information of a target of the first feature information
specifying, among the first feature information and the second feature information of a target included in one image, the identifier of the class obtained by classification of the first feature information; and
performing authentication using second feature information of a plurality of targets stored by the storage means that corresponds to the identifier of the class of the first feature information and second feature information included in the image.

### Supplementary Note 15

An authentication method wherein:
an authentication device that is connected to a storage means that corresponds to an identifier of a class of first feature information subjected to classification and that stores therein second feature information of a target of the first feature information
specifies, among the first feature information and the second feature information of a target that have been acquired, the identifier of the class obtained by classification of the first feature information; and
performs authentication using second feature information of a plurality of targets stored by the storage means that corresponds to the identifier of the class of the first feature information and the acquired second feature information.

### Supplementary Note 16

A program that causes a computer of an authentication device that is connected to a storage means that corresponds to an identifier of a class of first biometric information subjected to classification and that stores therein second biometric information of a person of the first biometric information to function as
a class specifying means that specifies, among the first biometric information and the second biometric information of a person included in one image, the identifier of the class obtained by classification of the first biometric information; and
an authentication means that performs authentication using second biometric information of a plurality of persons stored by the storage means that corresponds to the identifier of the class of the first biometric information and second biometric information included in the image.

### Supplementary Note 17

A program that causes a computer of an authentication device that is connected to a storage means that corresponds to an identifier of a class of first biometric information subjected to classification and that stores therein second biometric information of a person of the first biometric information to function as
a class specifying means that specifies, among the first biometric information and the second biometric information of a person that have been acquired, the identifier of the class obtained by classification of the first biometric information; and
an authentication means that performs authentication using second biometric information of a plurality of persons stored by the storage means that corresponds to the identifier of the class of the first biometric information and the acquired second biometric information.

### Supplementary Note 18

A program that causes a computer of an authentication device that is connected to a storage means that corresponds to an identifier of a class of first feature information subjected to classification and that stores therein second feature information of a target of the first feature information to function as
a class specifying means that specifies, among the first feature information and the second feature information of a target included in one image, the identifier of the class obtained by classification of the first feature information; and
an authentication means that performs authentication using second feature information of a plurality of targets stored by the storage means that corresponds to the identifier of the class of the first feature information and second feature information included in the image.

### Supplementary Note 19

A program that causes a computer of an authentication device that is connected to a storage means that corresponds to an identifier of a class of first feature information subjected to classification and that stores therein second feature information of a target of the first feature information to function as
a class specification means that specifies, among the first feature information and the second feature information of a target that have been acquired, the identifier of the class obtained by classification of the first feature information; and an authentication means that performs authentication using second feature information of a plurality of targets stored by the storage means that corresponds to the identifier of the class of the first feature information and the acquired second feature information.

### Supplementary Note 20

A storage medium that stores the program described in any one of Supplementary Note 16 to Supplementary Note 19.

### DESCRIPTION OF REFERENCE SIGNS

1 Authentication device
2 Mobile terminal
3 Camera
11 Acquisition portion
12 Class specifying portion
13 Registration portion
14 Authentication portion
15 Output portion
105 Database

What is claimed is:

1. An authentication device connected to a database that corresponds to an identifier of a class of first biometric information subjected to classification and that stores therein second biometric information of a person of the first biometric information, comprising:
at least one memory configured to store instructions; and
at least one processor configured to execute the instructions to:
specify, among the first biometric information and the second biometric information of a person included in one image, the identifier of the class obtained by classification of the first biometric information; and
perform authentication using second biometric information of a plurality of persons stored by the database storage means that corresponds to the identifier of the class of the first biometric information and second biometric information included in the image.

2. The authentication device according to claim 1, wherein the first biometric information is iris information of an eye.

3. The authentication device according to claim 1, wherein the first biometric information is iris information of a left eye and a right eye, respectively.

4. The authentication device according to claim 1, wherein the at least one processor is configured to execute the instructions to classify
the first biometric information into a class and register the second biometric information of the person of the first biometric information in the database that corresponds to the identifier of the class of the first biometric information.

5. The authentication device according to claim 4, wherein the at least one processor is configured to execute the instructions to classify the iris information for each of the left eye and the right eye, which is the first biometric information, into a class and register registers the second biometric information of the person of the first biometric information in the database that corresponds to the identifier of the class of the iris information of the left eye and the identifier of the class of the iris information of the right eye.

6. The authentication device according to claim 5, wherein the at least one processor is configured to execute the instructions to register the second biometric information of the person of the first biometric information in all databases specified by all the identifiers of the class relating to the left eye, in a case where only the identifier of the class obtained by classification of the iris information of the left eye can be specified, the iris information of the left eye being the second biometric information.

7. The authentication device according to claim 5, wherein the at least one processor is configured to execute the instructions to register the second biometric information of the person of the first biometric information in all databases storage means specified by all the identifiers of the class relating to the right eye, in a case where only the identifier of the class obtained by classification of the iris information of the right eye can be specified, the iris information of the right eye being the second biometric information.

8. The authentication device according to claim 1, wherein the second biometric information is feature information of a face in the image.

9. An authentication method, by an authentication device that is connected to a database that corresponds to an identifier of a class of first biometric information subjected to classification and that stores therein second biometric information of a person of the first biometric information, comprising:
specifying, among the first biometric information and the second biometric information of a person included in one image, the identifier of the class obtained by classification of the first biometric information; and
performing authentication using second biometric information of a plurality of persons stored by the database that corresponds to the identifier of the class of the first biometric information and second biometric information included in the image.

10. A non-transitory storage medium storing a program that causes a computer of an authentication device that is connected to a database that corresponds to an identifier of a class of first biometric information subjected to classification and that stores therein second biometric information of a person of the first biometric information to execute function as:
specifying, among the first biometric information and the second biometric information of a person included in one image, the identifier of the class obtained by classification of the first biometric information; and
performing authentication using second biometric information of a plurality of persons stored by the database that corresponds to the identifier of the class of the first biometric information and second biometric information included in the image.
